(19) United States
(12) Patent Application Publication
(10) Pub. No.: US 2003/0071867 A1
(43) Pub. Date: Apr. 17, 2003

(54) Printing apparatus

(76) Inventors: Antonio Hinojosa, Rubi Barcelona (ES); Martin Urrutia, Sant Cugat del Valles Barcelona (ES)

Correspondence Address: LADAS & PARRY, Suite 2100, 5670 Wilshire Boulevard, Los Angeles, CA, 90036-5679, US

(21) Appl. No.: 10/234,451

(22) Filed: Sep. 3, 2002

(30) Foreign Application Priority Data
Sep. 4, 2001 (EP) 01121125.7

(51) Int. Cl. B41J 29/393

(52) U.S. Cl. 347/19; 347/8

(57) ABSTRACT

A printing apparatus comprises a printing zone and a printhead for printing on a media having a printing side; the printing apparatus further comprises first media reference means arranged stationary within the apparatus and located upstream of said printhead in a direction of advance of the media through the apparatus. Said first media reference means engage the printing side of the media when the media is in a tensioned state in said printing zone and determine the position of said printing side of the media with respect to said printhead. The distance between the printhead and the printing side of the media is maintained for different thickness of the media being printed.

The present invention relates to a printing apparatus for printing on media of different thickness.

### BACKGROUND OF THE INVENTION

In printing apparatus, such as inkjet printers and plotters, the medium to be printed advances underneath a printing head with a plurality of nozzles. The printing head is mounted on a reciprocating carriage which travels on a supporting and guiding structure comprising slider rods.

The distance between the nozzles of the printing head and the media, which will be referred to hereinafter as PMS or “pen to media spacing”, is critical: if this distance is too big, the print quality will be poor, while if it is too small, the ink will not spread properly on the media, and there is a risk of ink smearing as well as damage to the media.

The problem of PMS adjustment is common to all kinds of media and printing apparatus, but it is particularly important when it is desired to print thick media, such as cardboard or fabric, in a conventional inkjet or similar printer.

In order to maintain the PMS in an optimal range, there are currently two possibilities: either limiting the media set that may be printed in the apparatus to a certain range of thickness, thus reducing the versatility of the machine, or providing for adjustment of the height of the printhead depending on the media thickness.

The solutions described for providing said adjustment of the printhead are based on a vertical movement or on a pivoting movement of the printhead carriage.

These solutions are necessarily complex and expensive, especially in the case of a vertical movement of the carriage, due to the number of parts involved and the need of guaranteeing accuracy in the positioning of the printhead.

Pivoting of the carriage has the further drawback of introducing a variation in the angle defined between the nozzle plate of the printhead and the plane of the media, commonly referred to as theta-x angle and defined as shown in appended FIG. 2. This angle variation may cause defects in the printing.

### DESCRIPTION OF THE INVENTION

Embodiments of the present invention seek to provide a printing apparatus in which it is possible to maintain an optimum PMS for different media thickness, whereby a wide range of media can be printed, without losing printing quality and without giving rise to a substantial increase in the cost of the apparatus.

The printing apparatus of the present invention, suitable for printing on media of different thickness, comprises a printing zone and a printhead for printing on a media having a printing side, said printing apparatus further comprising media reference means, wherein said media reference means comprise first media reference means arranged stationary within the apparatus and located upstream of said printhead in a direction of advance of the media through the apparatus, said first media reference means engaging the printing side of the media when the media is in a tensioned state in said printing zone and determining the position of said printing side of the media with respect to said printhead.

The distance between the printhead and the printing side of the media is thus maintained for different thickness of the media being printed.

In an embodiment of the invention, said media reference means comprise second media reference means arranged downstream of the printhead in said direction of advance of the media through the apparatus.

In one embodiment, said second media reference means comprise a tension roller which engages a side of the media which is opposite to the printing side.

The position of said tension roller may be adjustable; this feature allows to guarantee precision in the positioning of the media, avoiding theta-x angle variations, when the tension roller has to be arranged at a short distance from the printhead.

In another embodiment, said second media reference means arranged downstream of the printhead engage the printing side of the media.

This embodiment allows to maintain the media parallel to the printhead for any media thickness.

According to one possible configuration, the printer further comprises a reciprocating carriage on which the printhead is mounted, and a supporting and guiding structure on which said carriage can slide, wherein said first media reference means engaging the printing side of the media are integral with said supporting and guiding structure.

Since said structure is a part that needs to be manufactured with narrow tolerances in order to guarantee printing quality, adding another precision element on the same part doesn't increase significantly the manufacturing costs.

Preferably, said supporting and guiding structure comprises at least one slider rod for the carriage, said first media reference means comprising a surface that is parallel to said at least one slider rod.

The carriage and printhead are accurately positioned on the slider rod, and a surface parallel to said slider rod is thus suitable for referencing the printing side of the media.

Advantageously, said supporting and guiding structure comprises a projection having a free end, said surface of said first media reference means comprising a machined surface formed on said free end of said projection.

Machining of the surface is a simple way of ensuring parallelism with the slider rod.

According to another possible printer configuration, the printhead is a full width array printhead.

Preferably, said full width array printhead comprises a supporting structure, said first media reference means being fixed to said supporting structure.

This ensures accurate positioning of the media reference means, and thus of the media, with respect ot the printhead.

According to another aspect, the invention relates to a printing apparatus for printing on a media having a printing side, said apparatus comprising a full width array printhead with a supporting structure and media reference means which comprise first media reference means fixed to said supporting structure of the printhead, said first media reference means engaging the printing side of the media and determining the position of said printing side of the media with respect to the supporting structure of the printhead.

According to another aspect, the invention relates to a printing apparatus comprising a printhead for printing on a media having a printing side, said printing apparatus further comprising first media reference means and second media reference means, wherein said first media reference means are arranged stationary within the apparatus and located upstream of said printhead in a direction of advance of the media through the apparatus, and they engage the printing side of the media and determine the position of said printing side of the media with respect to said printhead, and wherein said second media reference means are located downstream of said printhead in said direction of advance of the media through the apparatus, the media being in a tensioned state between said first media reference means and said second media reference means.

Preferably said second media reference means comprise a tension roller.

According to another aspect, the invention relates to a method for printing on a media having a printing side, by means of a printing apparatus having a printing zone and a printhead, said method comprising:

advancing the media in a direction of advance through said printing apparatus;

providing first media reference means arranged stationary within said apparatus and located upstream of said printhead in the direction of advance of the media; and

tensioning the media in said printing zone causing said first media reference means to engage the printing side of the media and to determine the position of said printing side of the media with respect to said printhead.

### BRIEF DESCRIPTION OF THE DRAWINGS

A particular embodiment of the present invention will be described in the following, only by way of non-limiting example, with reference to the appended drawings, in which:

FIG. 1 is a diagram showing in side elevation the main parts of a printing apparatus according to an embodiment of the invention;

FIG. 2 is a diagram illustrating the concept of theta-x angle;

FIGS. 3 and 4 show an enlarged detail of the apparatus of FIG. 1, with media of two different thickness; and

FIG. 5 shows in perspective view a printing apparatus according to another embodiment of the invention.

### DESCRIPTION OF A PREFERRED EMBODIMENT

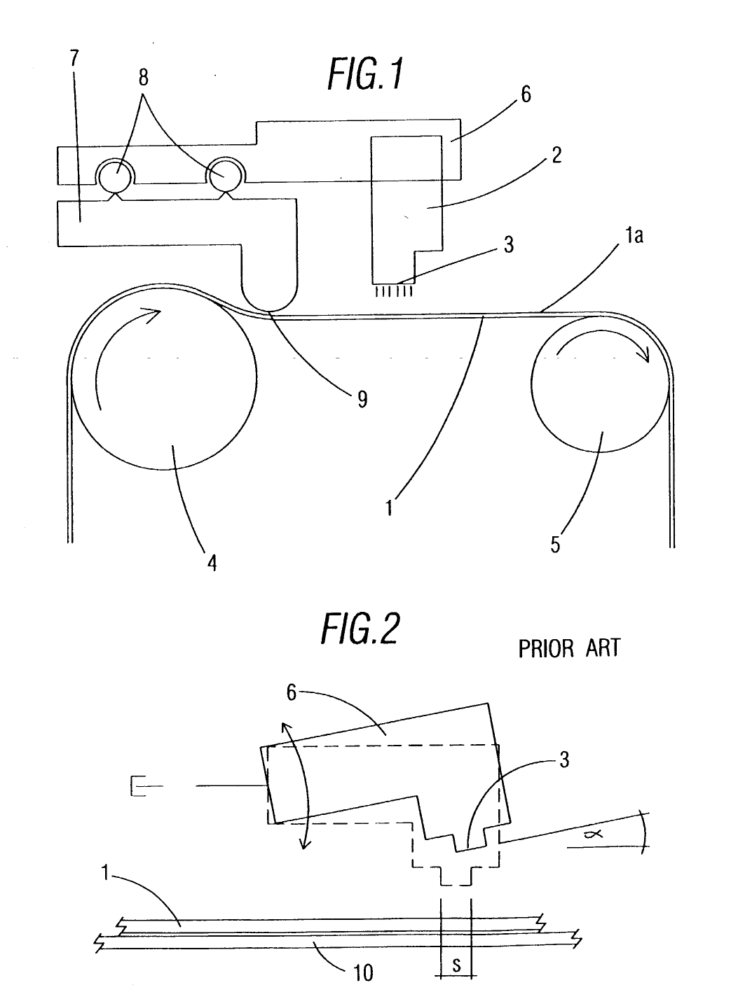

In FIG. 1, the main parts of an inkjet printer which are involved in PMS adjustment are shown, for a printer according to an embodiment of the present invention.

In the following, reference is made to an inkjet printer, but it has to be understood that the invention may apply to other types of printing apparatus.

A medium 1 to be printed is advanced underneath an inkjet pen or printhead 2 including a nozzle plate 3. The medium 1 is set between a main driving roller 4 arranged upstream of the printhead, and a tension roller 5 arranged downstream of the printhead.

The printhead 2 is mounted on a carriage 6 which reciprocates in a direction at right angles to the direction of advance of the medium. The carriage travels on a supporting and guiding structure 7, which includes a slider rod 8. This structure 7 is also referred to by the skilled man as “scan axis”.

The quality of the printing depends largely on the accuracy of the movement of the carriage, and therefore the slider rod 8 and the whole supporting and guiding structure 7 are high precision parts of the apparatus, which are manufactured with narrow tolerances.

According to the present invention, the position of the medium 1 with respect to the nozzle plate 3 of the printhead 2 is set through the upper or printing side 1a of the medium 1.

This is achieved by defining a positioning or reference surface 9 for the printing side 1a of the medium, said surface 9 being parallel to the slider rod 8 of the supporting and guiding structure 7.

The reference surface 9 engages the printing side la of the medium 1 and determines the position of said side with respect to the structure 7, thus allowing to keep an optimum PMS for different media thickness.

The medium 1 is thus kept floating beneath the printhead 2, instead of being supported on a platen like in the prior art.

As shown in FIG. 1, in a preferred embodiment the reference surface 9 is formed on a lower projection of the supporting and guiding structure 7. This facilitates accuracy in the relative positioning of the slider rod and the reference surface. Further, it is simple to manufacture, since all the relevant narrow-tolerance elements are in one and the same part. The surface is shown rounded, but it may have other shapes.

The reference surface 9 may also take the form of a separate element attached to the supporting structure 7 or even to the frame of the apparatus, as long as its position with respect to the slider rod 8 is guaranteed. It may also include a bar or roller in order to minimise friction with the media.

In the diagram of FIG. 1, the medium runs horizontally in the printing zone, and the reference surface 9 is therefore an upper abutment surface for the medium; however, a different arrangement is also possible, for example with the medium arranged vertically, as long as a reference surface for the printing side 1a of the medium 1 is provided. In the following, reference will be made to the layout shown in the drawings.

The main driving roller 4 is arranged slightly higher than the reference surface 9, such that the position of the top surface la of the medium 1 in the printing zone is determined by the reference surface 9 and the tension roller 5.

The reference surface 9 is arranged such that the vertical distance between the lowermost line of said surface 9 and the nozzle plate 3 of the printhead 2 is the optimum PMS.

Preferably, the position of the tension roller 5 ensures that the printing surface la is horizontal in the printing zone, in order to avoid theta-x angle variations.

In this regard, the importance of theta-angle is now discussed, with reference to FIG. 2, which represents very schematically a printer according to the prior art. The medium 1 being printed is supported on a platen 10 which keeps it flat, and a corresponding printer carriage 6 is arranged above the medium 1. The theta-x angle is the angle existing between the plane of the printhead nozzle plate 3 and the surface of the medium 1 being printed. This angle is indicated as ‘α’ in the figures.

If the carriage 6 is pivoted in order to adjust the PMS for different media thickness, as in the prior art solution shown in this figure, the theta-x angle α experiences an increase. When α is significant, the distance between the nozzle plate 3 and the medium 1 is not the same in all the swath length S of the printhead. This causes differences in the path travelled by the drops of ink projected from different nozzles of the printhead until they reach the medium, and thus causes defects in the printing.

In the above embodiment, a theta-x angle variation may occur if the tension roller 5 is not adjustable or placed at a distance from the printhead.

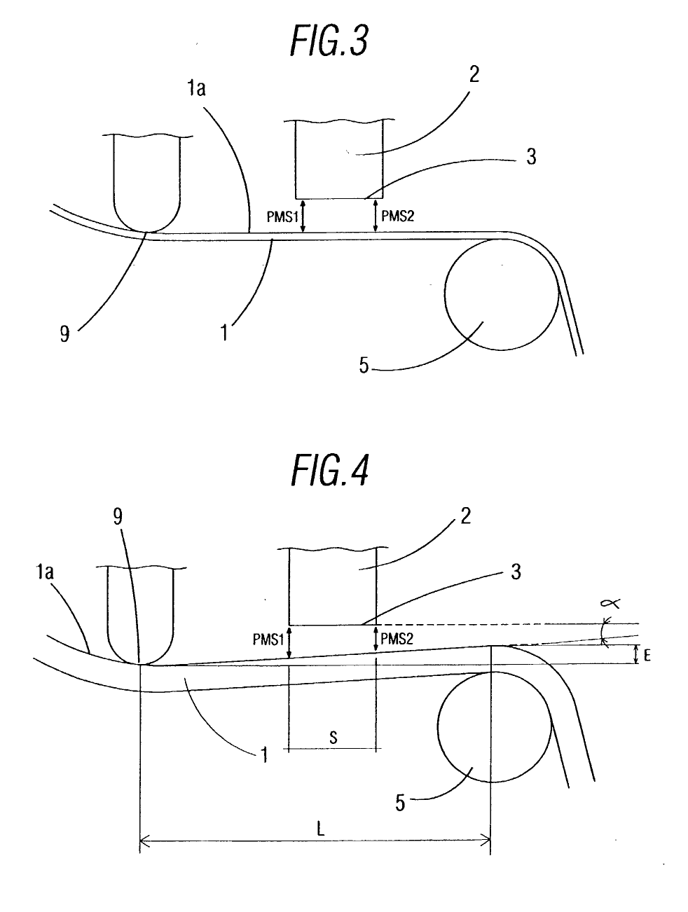

The position of the tension roller 5 will now be discussed, with reference to FIGS. 3 and 4, which show the three elements involved in the adjustment of PMS according to the present invention: the media reference surface 9, the nozzle plate 3 and the tension roller 5. In this figures, the thickness of the media has been exaggerated for better clarity.

In FIG. 3 a medium of normal thickness is shown being printed in the apparatus. The position of the roller is such that the upper, printing side 1a of the medium is horizontal and the distance (PMS) between the printing side 1a of the medium and the nozzle plate 3 is the same along the whole swath of the printhead, i.e. PMS1=PMS2.

However, when e.g. a thicker medium is printed in the same apparatus, as shown in FIG. 4, there will be a certain theta-x angle variation, if the tension roller 5 is not adjustable in height.

A similar problem would arise when printing media thinner than that shown in FIG. 3.

As discussed before, the theta-x angle variation causes that the distance between the printing side 1a of the medium and the nozzle plate 3 is different in different points along the swath length S of the printhead, i.e. PMS1≠PMS2. This may cause defects in the printing, and is thus undesirable.

It will be apparent that the value of the angle a depends greatly on the distance of the tension roller 5 with respect to main roller 4. If this distance is large, then α will be very small, and the error between PMS1 and PMS2 will be irrelevant.

However, in the cases where space or other constraints make it impossible to locate the tension roller away from the main roller, theta-x angle variations can be avoided simply by providing for adjustment of the vertical position of the tension roller 5.

The relations between geometrical parameters of the system are now discussed with reference to FIG. 4.

As can be seen in the drawing, a relation can be established between the maximum vertical error E, i.e. the vertical distance between the reference surface 9 and the printing side of the media on the tension roller 5, the distance L between the reference surface 9 and the tension roller 5, the swath length S and the error |PMS1−PMS2| across the swath length:

$$\frac{\vert PMS1 - PMS2 \vert}{S} = \frac{\vert E \vert}{L}$$

L depends on the horizontal position of the tension roller 5; E depends on the vertical position of the roller and on the thickness of the media; and S is a fixed parameter depending on the construction of the printhead.

In order to minimise the error across the swath length it is necessary to decrease the ratio S*|E|/L.

For a given swath length S and a desired maximum error, a maximum for the ratio |E|/L is obtained. For example, if the swath length is S=20 mm and the error between PMS1 and PMS2 must be less than ±2 mm, then E and L must comply with the equation

$$\frac{\vert E \vert}{L} \leq 0.1$$

By setting adequate geometric parameters, especially the distance L between the reference surface 30 and the tension roller, it is possible to design a printer with a low value α in all the desired range of media thickness, and thus allows good printing quality without requiring an adjustment in function of the thickness of the media.

According to another embodiment of the invention, it is possible to provide a second reference surface arranged downstream of the printhead, which also engages the printing side of the media.

In this case the medium is maintained parallel to the nozzle plate of the printhead between the two reference surfaces, and any problems related to the theta-x angle are avoided.

The second reference surface may be embodied with spiked wheels or similar elements in order to avoid ink smearing; alternatively, other means for avoiding this problem can be foreseen.

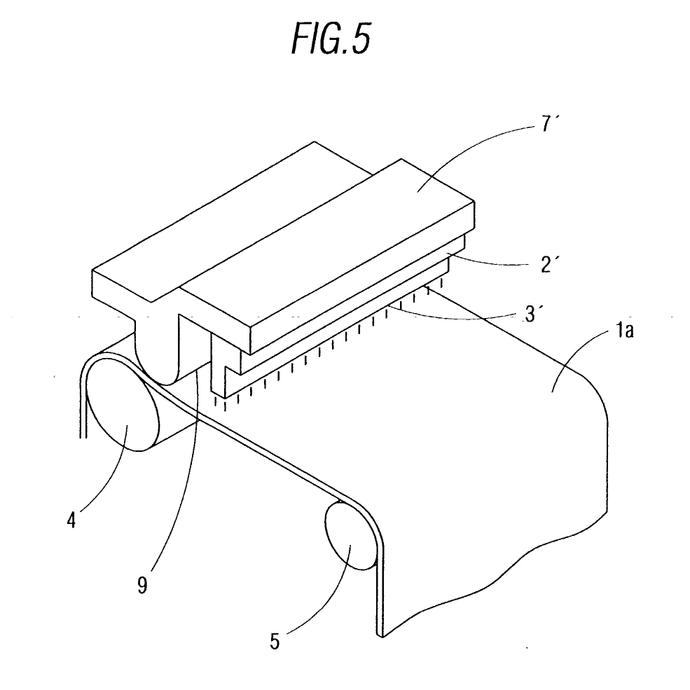

The invention may also be applied to a printer of the type having a full width array printer, i.e. a printer having a static printhead covering all the width of the media to be printed, instead of a printhead mounted on a carriage. Such a printer is shown in FIG. 5. The printhead 2′ and its nozzle plate 3′ cover substantially all the width of the medium, and are mounted on a supporting structure 7′.

In this case the reference surface 9 that engages the printing side 1a of the media may be integral with the printhead supporting structure 7′, and may thus be manufactured in one single part therewith.

Like in the case of FIG. 1, downstream of the printhead there may be a tension roller 5 or further reference means engaging the printing side of the media to avoid any theta-x angle variations.

1. A printing apparatus comprising a printing zone and a printhead for printing on a media having a printing side, said printing apparatus further comprising media reference means, wherein said media reference means comprise first media reference means arranged stationary within the apparatus and located upstream of said printhead in a direction of advance of the media through the apparatus, said first media reference means engaging the printing side of the media when the media is in a tensioned state in said printing zone and determining the position of said printing side of the media with respect to said printhead.

2. A printing apparatus as claimed in claim 1, wherein said media reference means comprise second media reference means arranged downstream of the printhead in said direction of advance of the media through the apparatus.

3. A printing apparatus as claimed in claim 2, wherein said second media reference means comprise a tension roller which engages a side of the media which is opposite to the printing side.

4. A printing apparatus as claimed in claim 3, wherein the position of said tension roller is adjustable.

5. A printing apparatus as claimed in claim 2, wherein said second media reference means arranged downstream of the printhead engage the printing side of the media.

6. A printing apparatus as claimed in claim 1, further comprising a reciprocating carriage on which the printhead is mounted, and a supporting and guiding structure on which said carriage can slide, wherein said first media reference means engaging the printing side of the media are integral with said supporting and guiding structure.

7. A printing apparatus as claimed in claim 6, wherein said supporting and guiding structure comprises at least one slider rod for the carriage, said first media reference means comprising a surface that is parallel to said at least one slider rod.

8. A printing apparatus as claimed in claim 7, wherein said supporting and guiding structure comprises a projection having a free end, said surface of said first media reference means comprising a machined surface formed on said free end of said projection.

9. A printing apparatus as claimed in claim 1, wherein the printhead is a full width array printhead.

10. A printing apparatus as claimed in claim 9, wherein said full width array printhead comprises a supporting structure, said first media reference means being fixed to said supporting structure.

11. A printing apparatus for printing on a media having a printing side, said apparatus comprising a full width array printhead with a supporting structure and media reference means which comprise first media reference means fixed to said supporting structure of the printhead, said first media reference means engaging the printing side of the media and determining the position of said printing side of the media with respect to the supporting structure of the printhead.

12. A printing apparatus comprising a printhead for printing on a media having a printing side, said printing apparatus further comprising first media reference means and second media reference means, wherein said first media reference means are arranged stationary within the apparatus and located upstream of said printhead in a direction of advance of the media through the apparatus, and they engage the printing side of the media and determine the position of said printing side of the media with respect to said printhead, and wherein said second media reference means are located downstream of said printhead in said direction of advance of the media through the apparatus, the media being in a tensioned state between said first media reference means and said second media reference means.

13. A printing apparatus as claimed in claim 12, wherein said second media reference means comprise a tension roller.

14. A method for printing on a media having a printing side, by means of a printing apparatus having a printing zone and a printhead, said method comprising:
advancing the media in a direction of advance through said printing apparatus;
providing first media reference means arranged stationary within said apparatus and located upstream of said printhead in the direction of advance of the media; and
tensioning the media in said printing zone causing said first media reference means to engage the printing side of the media and to determine the position of said printing side of the media with respect to said printhead.
